(19) United States
(12) Patent Application Publication
(10) Pub. No.: US 2024/0286965 A1
(43) Pub. Date: Aug. 29, 2024

(54) METHOD OF PREPARATION OF A CONSTRUCTION ELEMENT BY CARBONATION OF CEMENT

(71) Applicant: HOLCIM TECHNOLOGY LTD, ZUG (CH)

(72) Inventors: Bruno HUET, HOLDERBANK (CH); Vincent BRIAUD, HOLDERBANK (CH); Vincent MEYER, HOLDERBANK (CH); Guillaume LOUBET, HOLDERBANK (CH); Christophe LEVY, HOLDERBANK (CH)

(21) Appl. No.: 18/572,588

(22) PCT Filed: Jun. 22, 2022
(86) PCT No.: PCT/EP2022/066982

§ 371 Date: Dec. 20, 2023

(30) Foreign Application Priority Data
Jun. 23, 2021 (EP) 21305864.7

(51) Int. Cl. C04B 40/02; B28B 11/24; C04B 24/00; C04B 24/10; C04B 24/12; C04B 28/04; C04B 40/00; C04B 103/14; C04B 103/20

(52) U.S. Cl. CPC C04B 40/0236; B28B 11/245; C04B 24/003; C04B 24/10; C04B 24/121; C04B 24/123; C04B 28/04; C04B 40/0032; C04B 40/0281; C04B 2103/14; C04B 2103/20

(57) ABSTRACT

A method of preparation of a construction element by carbonation, includes a) preparing a composition containing a cement, water and chemical additives; b) pre-drying the composition; then c) placing the pre-dried composition in a chamber of an incubator, the chamber containing at least one inlet and one outlet, the pre-dried composition being carbonated, in a carbonation procedure, by feeding into the chamber, through the inlet, a flow of CO₂ containing gas, variations of the CO₂ concentration in the chamber being kept below 10% of a reference value during the whole carbonation procedure, during the carbonation procedure, the pressure within the chamber being atmospheric pressure, the relative humidity within the chamber being above 80° % and the temperature within the chamber ranging from 20° C. to 80° C. The chemical additives in the composition include more than 0.05% in weight, compared to the total weight of the cement, of a cement hydration retarder.

The present disclosure relates to methods of making Ordinary Portland Cement (OPC) construction elements, for reducing the greenhouse gas emissions associated with making concrete construction elements, and for sequestering carbon dioxide. The present disclosure further relates to methods of optimizing massive carbonation of OPC for early age hardening of constructions elements.

The present disclosure relates to a method comprising a carbonation step of a composition comprising a cement, preferably a cement as defined in the standard NF-EN-197-1 of April 2012, more preferably a CEM I, a CEM II or a CEM III.

Carbonation of Portland cement involves the calcium-silicate components of Portland cement, namely, tri-calcium-silicate (3CaO·SiO₂; also referred to as C3S and called alite) and di-calcium-silicate (2CaO·SiO₂; also referred to as C2S and called belite). The CO₂ gas reacts with these calcium-silicates, in the presence of water, to form 3CaO·2SiO₂·3H₂O (also referred to as C—S—H) and CaCO₃ (according to Equations 1 and 2 below, 1974-JACS-Young_Accelerated Curing of Compacted Calcium Silicate Mortars on Exposure to CO₂; 1979-JACS-Goodbrake-Young-Berger Reaction of Beta-Dicalcium Silicate and Tricalcium Silicate with Carbon Dioxide and Water Vapor; 1979-CCR-Bukowski_Reactivity and strength development of CO₂ activated non-hydraulic calcium silicates).

$$\begin{matrix}Equation 1 & \\ 2 ( 3 {CaO•SiO}_{2} ) + 3 {CO}_{2} + 3 {H}_{2} O \text{=>} 3 {CaO•SiO}_{2} {•3H}_{2} O + 3 {CaCO}_{3} & ( Eq . 1 )\end{matrix}$$

$$\begin{matrix}Equation 2 & \\ 2 ( 2 {CaO•SiO}_{2} ) + {CO}_{2} + 3 {H}_{2} O \text{=>} 3 {CaO•2SiO}_{2} {•3H}_{2} O + 3 {CaCO}_{3} & ( Eq . 2 )\end{matrix}$$

Method and apparatus for curing CO₂ composition material objects at near ambient temperature and pressure are disclosed in WO2015/112655. This method involves the use of a specific composition material which is not ordinary Portland Cement (OPC). In addition, the process involves alteration of the gas flow repeatedly from time to time during curing process.

EP 3 687 960 discloses the use of carbon dioxide gas to cure concrete media, which may be Portland cement, by applying a pressure differential, created through a partial replacement of the original ambient volume of air present in a curing enclosure with pure CO₂ gas. The process may further comprise an air displacement step preceding carbonation intended for creating suction and achieving sub-atmospheric pressures.

EP 3 362 237 discloses a carbonation process comprising a step of carbonating pre-dried concrete precast units, which may be based on Portland cement, by feeding CO₂ gas into a closed air-tight chamber under near ambient atmospheric pressure or low-pressure conditions, wherein said pre-dried concrete block had lost between 25 to 50% its mix water content. Thus, in that process carbonation occurs in airtight chambers.

There is still a need for simple and industrial method for carbonating cement compositions. Surprisingly, the inventors found that controlling hydration of a cement composition leads to an improved carbonation, especially on large samples, having a largest dimension greater than 5 cm, preferably greater than 10 cm, of concrete elements made from the said cement composition.

### SUMMARY OF THE INVENTION

The invention is directed to a method of preparation of a construction element by carbonation, comprising the consecutive steps of:
a) preparing a composition containing a cement, water and chemical additives; then
b) pre-drying the composition; then
c) placing the pre-dried composition in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure, the relative humidity within the chamber of the incubator is above 80° % and the temperature within the chamber of the incubator is ranging from 20° C. to 80° C.,
characterized in that the chemical additives in the composition comprise more than 0.05% in weight, compared to the total weight of the cement, of a cement hydration retarder.

Advantageously, the composition comprises more than 0.05% to 3%, preferably from 0.1% to 3%, more preferably from 0.1% to 1%, of the cement hydration retarder, the percentages are expressed in weight compared to the total weight of the cement.

The cement hydration retarder is preferably selected from sodium gluconate, Amino Tris Methylene Phosphonic acid (ATMP), saccharose, or Ethylene Diamine Tetraacetic acid (EDTA), or mixtures thereof.

The cement hydration retarder is preferably selected from ATMP, EDTA, or mixtures thereof.

Advantageously, the additives further contain a carbonation accelerator, preferably selected from TEA, TIPA, calcium salts, sodium salts, or mixtures thereof.

Advantageously, the cement comprises at least 20%, preferentially 50%, in weight compared to the total weight cement, of Portland clinker.

Advantageously, the cement further comprises mineral component selected from granulated blast furnace slag, pozzolanic materials, fly ashes, burnt shale, limestone, silica fume and combinations thereof.

The cement is preferably selected from a CEM I or a CEM III.

The composition of step a) has preferably a weight water/cement ratio below 0.6, preferably below 0.4, preferably below 0.32.

The composition of step a) is preferably selected from a cement paste, a mortar, or a concrete.

Advantageously, step b) is conducted at a temperature ranging from 20 to 80° C. and at a controlled relative humidity, ranging from 10 to 95%.

Advantageously, step b) is conducted until the composition has a water content ranging from 0.1 to 0.3, preferably from 0.1 to 0.2.

Advantageously, the flow of CO₂ containing gas is fed through the inlet into the chamber of the incubator at a flow rate of 0.5 L_gas/L_sample/h to 5 L_gas/L_sample/h.

The temperature within the chamber of the incubator is preferably ranging from 60° C. to 80° C.

The relative humidity within the chamber of the incubator is preferably above 90%.

The chamber of the incubator is preferably ventilated.

The invention is also directed to a method for storing carbon dioxide in a construction element, comprising the consecutive steps of:
a) preparing a composition containing a cement, water and chemical additives; then
b) pre-drying the composition; then
c) placing the pre-dried composition in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure, the relative humidity within the chamber of the incubator is above 80° % and the temperature within the chamber of the incubator is ranging from 20° C. to 80° C., characterized in that the chemical additives in the composition comprise more than 0.05% in weight, compared to the total weight of the cement, of a cement hydration retarder.

The steps, conditions and components are preferably as further described above and below.

The invention is also directed to the use of chemical additive comprising cement hydration retarder in a cement composition, the composition comprising more than 0.05% in weight, compared to the total weight of the cement, of the cement hydration retarder for improving CO₂ uptake of the cement composition after carbonation.

The chemical additive preferably further comprising carbonation accelerator.

The carbonation is preferably conducted as described above and below.

The composition is preferably as described above and below

The above and other objects, features and advantages of this invention will be apparent in the following detailed description.

### Definitions

Cement: a cement is a hydraulic binder comprising at least 50% by weight of calcium oxide (CaO) and silicon dioxide (SiO₂), in weight compared to the total weight of the cement. The cement is preferably a cement as defined in the standard NF-EN-197-1 of April 2012. The cements defined in standard NF-EN197-1 of April 2012 are grouped in 5 different families: CEM I, CEM II, CEM III, CEM IV and CEM V. The cement preferably comprises at least 95%; in weight compared to the total weight of the cement, of main constituent selected from the group consisting of Portland clinker and combinations of Portland clinker with mineral component.
Mineral component: The mineral component comprises one or at least one of the components that are defined in paragraphs 5.2.2 to 5.2.7 of the same standard NF-EN197-1 of April 2012. Accordingly, the mineral component is selected from the group consisting of granulated blast furnace slag, pozzolanic materials, fly ashes, burnt shale, limestone, silica fume and combinations thereof.
CO₂ containing gas: a gas that contains a minimum of 5% in volume of CO₂ compared to the total volume of the dry gas composition. The terms “CO₂ gas” can also be used. “CO₂ gas” also means a gas that contains a minimum of 5% in volume of CO₂ by volume of total dry gas.
Constant CO₂ concentration: variations of the CO₂ concentration in the chamber of the incubator are kept below 10% of a reference value during the whole carbonation step. The CO₂ concentration in the chamber can be controlled or measured by using a CO₂ flow meter and/or a CO₂ concentration meter. The CO₂ meter can be inside or outside the chamber. Preferably, the CO₂ concentration in the chamber can be measured, preferably continuously or periodically, by using dedicated CO₂ sensors such as infrared CO₂ meter. Preferably, the measurement is carried out continuously.
Sample of large size: mortar or concrete sample having a largest dimension greater than 5 cm, preferably greater than 10 cm. The maximal value for the largest dimension is dependent only from the dimensions of the chamber of the incubator in which the sample will be placed for carbonation. Preferably the sample has a thickness (or shortest dimension) greater than 1 cm, more preferably greater than 5 cm. Thus, the thickness can be for example of 8 cm or 10 cm, which are usual thickness for a paver.

### DETAILED DESCRIPTION

It was discovered that controlling hydration can maximize carbonation. The method has been implemented on cement paste but also on mortar and on concrete. In particular the method has been implemented on mortar or concrete samples of large size.

The invention allows the use of standard OPC that complies with the definition given in the standard EN 197-1 of April 2012.

The present disclosure relates to a method comprising the addition of a retarder to limit the hydration of a cement composition and postpone the hydration beyond the required drying duration for optimum carbonation.

The present disclosure relates to a method of preparation of a construction element by carbonation of a cement composition, comprising the consecutive steps of:
a) preparing a composition containing a cement, water and chemical additives; then
b) pre-drying the composition; then
c) placing the pre-dried composition in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure, the relative humidity within the chamber of the incubator is above 80% and the temperature within the chamber of the incubator is ranging from 20° C. to 80° C.,
characterized in that the chemical additives in the composition comprise more than 0.05% in weight, compared to the total weight of the cement, of a cement hydration retarder.

Thus, the method involves the addition to the cement composition of a cement hydration retarder that prevents the composition from hardening without CO₂ addition. Once CO₂ is added, the composition containing cement will harden by carbonation of the cement.

### Step a):

The composition preferably comprises more than 0.05% to 3%, preferably from 0.1% to 3%, more preferably from 0.1% to 1%, of the cement hydration retarder, the percentages are expressed in weight compared to the total weight of the cement. At these dosages, the cement hydration retarder is efficient to postpone hydration of the cement, even at temperature above 20° C., or preferably above 50° C., preferably up to 80° C.

The cement hydration retarder is preferably selected from sodium gluconate, amino tris methylene phosphonic acid (ATMP), saccharose, ethylene diamine tetraacetic acid (EDTA), or mixtures thereof. More preferably, the cement hydration retarder is selected from ATMP, EDTA, or mixtures thereof.

The composition can comprise more than 0.05% to 1%, preferably from 0.1% to 1%, of gluconate, the percentages are expressed in weight compared to the total weight of the cement.

The composition can comprise more than 0.05% to 1%, preferably from 0.1% to 1%, of ATMP, the percentages are expressed in weight compared to the total weight of the cement.

The composition can comprise more than 0.05% to 3%, preferably from 0.1% to 3%, of saccharose, the percentages are expressed in weight compared to the total weight of the cement.

The composition can comprise more than 0.05% to 2%, preferably from 0.1% to 2%, of EDTA, the percentages are expressed in weight compared to the total weight of the cement.

The composition can further comprise other chemical additive, and in particular a carbonation accelerator. The accelerator can be used to maximize carbonation.

The composition preferably comprises from 0% to 3%, preferably from 0.05% to 3%, preferably from 0.1% to 2%, more preferably from 0.1% to 1%, of the carbonation accelerator, the percentages are expressed in weight compared to the total weight of the cement.

The carbonation accelerator is preferably selected from triethylamine (TEA), triisopropanolamine (TIPA), calcium salts, sodium salts, or mixtures thereof.

Calcium salts are preferably selected from Ca(NO₃)₂, CaCl₂ or mixtures thereof.

Sodium salts are preferably selected from NaHCO₃, Na₂CO₃, NaCl or mixtures thereof.

The composition can comprise from 0.1% to 1%, of TEA, the percentages are expressed in weight compared to the total weight of the cement.

The composition can comprise from 0.1% to 1%, of TIPA, the percentages are expressed in weight compared to the total weight of the cement.

The composition can comprise from 0.1% to 3%, of calcium salts, the percentages are expressed in weight compared to the total weight of the cement.

The composition can comprise from 0.1% to 1%, of sodium salts, the percentages are expressed in weight compared to the total weight of the cement.

The composition comprises cement, where the cement is as defined previously.

Preferably, the cement comprises at least 20%, preferentially 50%, in weight compared to the total weight cement, of Portland clinker.

Preferably the cement is selected from CEM I, CEM II or CEM III, as defined in the standard NF-EN-197-1 of April 2012. More preferably the cement is selected from CEM I or CEM III. A CEM III cement is preferably selected from CEM III/A or CEM III/B.

The cement may comprise at least 95%, in weight compared to the total weight cement, of Portland clinker. The cement is thus a CEM I cement.

The cement may comprise mineral component selected from granulated blast furnace slag, pozzolanic materials, fly ashes, burnt shale, limestone, silica fume and combinations thereof.

Pozzolanic materials include natural pozzolana, natural calcined pozzolana, such as metakaolin, and combinations thereof. Fly ashes include silicious fly ash, calcareous fly ash, and combinations thereof.

The cement may comprise at least 65% to 94% of Portland clinker and from 6% to 35% of mineral component selected from granulated blast furnace slag, pozzolanic materials, fly ashes, burnt shale, limestone, silica fume and combinations thereof, the percentages being expressed in weight compared to the total weight cement. The cement is thus a CEM II cement.

The cement may comprise from 35 to 64% of Portland clinker and from 36% to 65% of blast furnace slag, the percentages being expressed in weight compared to the total weight cement.

The cement is thus a CEM III/A cement.

The cement may comprise from 20 to 34% of Portland clinker and from 66% to 80% of blast furnace slag, the percentages being expressed in weight compared to the total weight cement.

The cement is thus a CEM III/B cement.

The addition of mineral component further lowers the overall carbon footprint.

The composition of step a) also comprises water and preferably has a weight water/cement ratio below 0.6, preferably below 0.5, more preferably below 0.32. The composition of step a) has preferably a weight water/cement ratio ranging from 0.15 to 0.5, preferably ranging from 0.15 to 0.4, and more preferably ranging from 0.15 to 0.32.

The composition may also comprise admixtures for rheology, in particular a water reducer, such as a plasticiser or a super-plasticiser.

The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein as well as superplasticizers.

Superplasticizers can be selected from sulfonated condensates of naphthalene formaldehyde (generally a sodium salt), sulfonate condensates of melamine formaldehyde, modified lignosulfonates, polycarboxylates, e.g. polyacrylates (generally sodium salt), polycarboxylate ethers, polycarboxylate esters, copolymers containing a polyethylene glycol grafted on a polycarboxylate, sodium polycarboxylates-polysulfonates, and combinations thereof. In order to reduce the total amount of alkaline salts, the superplasticizer may be used as a calcium salt rather than as a sodium salt.

Preferably, the composition of step a) is selected from a cement paste, a mortar, or a concrete.

The method can be applied to all precast concrete products (both reinforced and non-reinforced), including, but not limited to, masonry units, pavers, pipes, and hollow-core slabs.

When the composition is a mortar or a concrete composition, the composition will further comprise aggregates.

Aggregates include sand (whose particles generally have a maximum size (Dmax) of less than or equal to 4 mm), and gravel (whose particles generally have a minimum size (d min) greater than 4 mm and preferably a Dmax less than or equal to 20 mm).

The aggregates include calcareous, siliceous, and silico-calcareous materials. They include natural, artificial, waste and recycled materials.

During step a), the components of the composition are mixed under conventional manner, for example in a mixer such as a Perrier mixer. If need be, the sand and/or aggregates can be pre-saturated with water before mixing, to allow a more accurate control of the water/cement ratio in the composition.

After mixing, before step b), the composition of step a) is placed on a support.

Preferably, the cement paste is directly spread in a support, such as a cup, preferably an aluminum cup.

Preferably, the mortar or concrete composition is spread in a mold, unmolded before step b) and the solid is placed on a support. If need be, the composition is slightly pre-dried before unmolding it; meaning that the pre-drying is the minimal drying required for unmolding.

Preferably, the mortar or concrete composition is compacted, for example using a gyratory compactor. From 50 to 500 cycles can be performed to reach maximum density of the composition. Compacting the composition may allow to obtain solid samples which can be handled and directly placed in the chamber of step b) without pre-drying.

Thus, the method can comprise a step, preceding step b), of compacting or molding, or otherwise preparing in a solid form, the composition of step a). A solid form is a cohesive shape that can be handled. If molded, the composition is unmolded before step b).

### Step b)

The composition of step a) is then pre-dried during step b).

The pre-drying step b) consists in heating the composition to evaporate a part of the water.

The composition is not fully dried during step b). Step b) is a pre-drying step without CO₂ addition.

Preferably, step b) is conducted until the composition has a water content ranging from 0.1 to 0.3, preferably from 0.1 to 0.2.

This water content is expressed in terms of remaining mass of liquid water after drying, normalized by the mass of cement in the composition.

Preferably, mass loss is linear with time.

The pre-drying step can be conducted in any suitable drying device. For example, the composition of step a) is placed in a climatic chamber. The drying rate is varied by changing the temperature and relative humidity in a market available climatic chamber. Preferably, the conditions are chosen to allow homogeneity of drying, i.e. by controlling that the mass loss is linear with time.

Preferably, step b) is conducted at a temperature ranging from 20 to 80° C.

Preferably, step b) is conducted at a controlled relative humidity, ranging from 10 to 95%.

The drying is stopped once a targeted water content, preferably as defined above, is reached: the drying duration may vary from 15 minutes to a few days depending on conditions and on sample size.

### Step c)

The pre-dried composition obtained after step b), optionally with its support, is placed in an incubator, and more precisely into an interior space of the incubator, called the chamber of the incubator. The chamber of the incubator can also be called a curing chamber or carbonation chamber or vacuum oven. The chamber of the incubator is preferably a closed volume. In the incubator's chamber, the composition is isolated from the external environment of the incubator, and in particular from the atmospheric air. Preferably the chamber is a tight chamber. In particular, the leakage rate is below 100 hPa/day. The incubator comprises an access closed by a door, a hatch or any other barrier that allows ingress into and egress from the chamber, while ensuring that the chamber is still isolated when the access is closed. The access is used for introducing the composition into the curing chamber and for removing it from the curing chamber.

The incubator contains at least one inlet and one outlet terminating in the chamber, and forming gas ducts. The inlet allows introduction of the CO₂ gas into the chamber of the incubator. The outlet allows exit of the CO₂ gas out the chamber of the incubator. Preferably, the incubator contains one inlet and one outlet. The CO₂ concentration of gas at inlet and outlet can be measured with sensors.

The gas ducts (inlet/outlet) allow both temperature control and gas control (composition, pressure) within the chamber, for example by varying the flow rate or the properties of the gas.

The incubator can also comprise CO₂ sensors to monitor CO₂ within the chamber, in particular infrared CO₂ meter. The incubator preferably comprises at least one CO₂ sensor at the inlet and one CO₂ sensor at the outlet, for sensing a CO₂ concentration of the gas circulating in the inlet or the outlet, respectively.

The incubator can also comprise temperature sensors to monitor temperature within the chamber.

The chamber of the incubator can be purged of air before starting carbonation, once the pre-dried composition is placed in the chamber and the chamber is closed. For example, a vacuum pump is used to flush the initial air in the chamber of the incubator with the CO₂ gas flow.

Preferably, the chamber may be ventilated. Accordingly, the chamber may comprise fans located at different heights of the chamber, including, if need be, the ceiling of the chamber, to favor gas composition homogeneity in the entire volume of the chamber.

The composition is carbonated, in a carbonation step, by feeding into the chamber of the incubator, through the inlet, a flow of CO₂ gas.

The CO₂ gas flow is introduced in the chamber of the incubator, through the inlet, so that the variations of the CO₂ concentration in the chamber of the incubator are kept below 10% of a reference value, preferably below 5% of the reference value. The reference value is fixed on a case-by-case basis. Accordingly, the gaseous CO₂ concentration in the gas within the chamber of the incubator, specifically near the inlet where a CO₂ sensor is placed, is more or less constant. Preferably, the variation of the CO₂ concentration is thus controlled, below the above defined values, during at least 80% of the duration of the carbonation step, preferably during at least 90% of the duration of the carbonation step, more preferably during at least 95% of the duration of the carbonation step, most preferably during the whole carbonation step. Accordingly, the CO₂ gas flow is a continuous flow. Accordingly, the CO₂ gas flow is not interrupted during the carbonation step. The CO₂ gas flow can be interrupted only for calculating CO₂ depletion as detailed below.

Preferably, the gas present in the chamber of incubator has a constant composition during the carbonation step, especially during the whole carbonation step. Constant means a variation kept below 10% of a reference value, preferably below 5% of the reference value. Accordingly, during the carbonation step, especially during the whole carbonation step, the sample is exposed within the chamber to a CO₂-rich confined atmosphere having a constant composition. Preferably, the flow of CO₂ containing gas is fed through the inlet into the chamber of the incubator at a flow rate of 0.5 L_gas/L_sample/h to 5 L_gas/L_sample/h.

The CO₂ gas can be any kind of gas containing CO₂, including an industrial waste gas containing CO₂ such as CO₂ gas directly exiting cement kilns. The CO₂ concentration in the gas can range from 5% to 100%, preferably from 10% to 100%; in volume compared to the total volume of the dry gas.

The CO₂ gas can be exhaust gas, in particular CO₂ gas directly exiting cement kilns. The CO₂ concentration in the gas can range from 5% to 100%, preferably from 10% to 50%, more preferably 10% to 30%; in volume compared to the total volume of the dry gas.

The CO₂ gas flow may be pre-saturated with water vapor before injection in the chamber of the incubator. The relative humidity (RH) of the CO₂ gas is preferably from 60% to 100%, at the feeding temperature and feeding pressure.

The CO₂ gas is fed at atmospheric pressure (1 013.25 hPa) or with slight overpressure to sustain constant composition (as defined above) within the chamber. The slight overpressure can be of 1000 to 3000 Pa. The CO₂ gas can thus be fed at a pressure ranging from 1 013.25 hPa to 1 043.25 hPa, preferably from 1 013.25 hPa to 1 023.25 hPa.

The CO₂ gas flow can be heated at a temperature ranging from 20 to 120° C., preferably from 60° C. to 120° C., more preferably from 60° C. to 80° C.

In an embodiment, the CO₂ gas flow is be pre-saturated with water vapor before injection in the chamber of the incubator. The relative humidity of the CO₂ gas is preferably from 60% to 100%. The CO₂ gas flow is preferably heated at a temperature higher than chamber temperature, preferably at a temperature ranging from 60° C. to 120° C.

During the carbonation step, the pressure within the chamber of the incubator is atmospheric pressure +/−100 hPa.

During the carbonation step, the relative humidity within the chamber of the incubator is above 80° %, preferably above 90° %. The relative humidity can be until 100%. The relative humidity can be controlled with a tank of deionized water laid on the bottom of the chamber of the incubator. The relative humidity is here considered at the temperature within the chamber and the pressure within the chamber.

During the carbonation step, the temperature within the chamber of the incubator is ranging from 20° C. to 100° C., preferably from 40° C. to 90° C., preferably from 50° C. to 85° C. and more preferably from 60° C. to 80° C.

During the carbonation step, the chamber is preferably ventilated. Ventilation within the chamber of the incubator aims to favor gas composition homogeneity in the entire volume of the chamber. In particular, ventilation aims to avoid local condensation issues due to the relative humidity.

The duration of carbonation step is variable, generally from 1 hour to 3 days.

The duration of the carbonation step can be regulated by measuring CO₂ depletion. CO₂ depletion is calculated by closing the CO₂ inlet for a 2 to 5 minutes and measuring the CO₂ depletion rate during that time, since the chamber of the incubator is tight during that duration.

The duration of the carbonation step can be regulated by determining average maturity of cement in composition. That determination can be done automatically by calculating the integral of point measurement of mass flow rate.

Once carbonation step is ended, the composition is removed from the chamber of the incubator. The composition can then be stored or used directly. The composition can be placed in a post water condensing unit, after exiting the incubator and before use.

The mass of composition obtained by the method increases, compared to the initial mass of the composition placed in the chamber of the incubator, due to water uptake and CO₂ uptake.

The method of measurement of hydration and carbonation amount is disclosed in the examples and can be applied generally to any composition obtained by the disclosed method.

The disclosed method allows a significant CO₂ binding capacity, with a CO₂ uptake preferably greater than 0.15, more preferably greater than 0.20.

The CO₂ uptake is the value Δm_{CO2} calculated according to the equation 5 disclosed in the examples.

In addition, the compositions obtained by the methods show good mechanical performance.

The disclosed method allows to obtain carbonated composition, with significant CO₂ binding capacity and show good mechanical performance while using standard OPC.

Accordingly, the invention is also directed to a method for storing carbon dioxide in a construction element by carbonation of a cement composition, comprising the consecutive steps of:
a) preparing a composition containing a cement, water and chemical additives; then
b) pre-drying the composition; then
c) placing the pre-dried composition in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas
variations of the CO₂ concentration in the chamber of the incubator are kept below 10% of a reference value during the whole carbonation step,
during the carbonation, the pressure within the chamber of the incubator is atmospheric pressure, the relative humidity within the chamber of the incubator is above 80° % and the temperature within the chamber of the incubator is ranging from 20° C. to 80° C.
characterized in that the chemical additives in the composition comprise more than 0.05% in weight, compared to the total weight of the cement, of a cement hydration retarder.

The composition is as disclosed previously. Steps a) to c) are as disclosed previously. All embodiments disclosed previously for the method of preparation of a construction element also apply here.

It has been discovered that controlling of hydration of cement, meaning retarding the hydration of the cement so it starts after the carbonation reaction, ensures optimum carbonation degree of cement while ensuring mechanical performance, including for large building product obtained by carbonation of sample of large size.

Accordingly, the invention is also directed to the use of chemical additive comprising cement hydration retarder in a cement composition, the composition comprising more than 0.05% in weight, compared to the total weight of the cement, of the cement hydration retarder for improving CO₂ uptake of the cement composition after carbonation.

Preferably, the chemical additive further comprising carbonation accelerator.

Preferably, the composition is as disclosed previously.

Preferably, carbonation is conduction by a two-step process comprising
pre-drying of the composition, as disclosed previously;
carbonation of the pre-dried composition, as disclosed previously.

The following non-restrictive examples illustrate embodiments of the invention.

### EXAMPLES

In the following examples, when a range is expressed by the formula [x, y], it corresponds to a range from x to y. For example, a range [0, 1] means a range from 0 to 1.

### Components Used

### Cement:

CEM I 52.5 N from le Teil cement plant (Lafarge France)
CEM III/B from La Malle cement Plant (Lafarge France) comprising at least 20.-wt % of Portland clinker
   Retarders and their Dosage with Respect to Cement; Id Est with Respect to CEM I or CEM III/B Accordingly:
Gluconate (e.g. CER PLAST), with dosage in the range [0, 1] wt %
Amino Tris Methylene Phosphonic acid (ATMP) with dosage in the range [0, 1] wt %
Saccharose with dosage in the range [0, 3] wt %
Ethylene Diamine Tetraacetic acid (EDTA) with dosage in the range [0, 2] wt %

### Carbonation Improvers:

Triethanolmamine TEA with dosage in the range [0, 1] wt %
Tri Iso Propanol Amine (TIPA) with dosage in the range [0, 1] wt %
Calcium Salt (e.g. Ca(NO₃)₂ or CaCl₂) with dosage in the range [0, 3] wt %
Sodium Salt (e.g. NaHCO₃, Na₂CO₃, or NaCl) with dosage in the range [0, 1] wt %

### Admixtures for Rheology:

the forming of concrete is done at room temperature, any commercial superplasticizer can be used
No superplasticizer was required for the EN mortars
A PolyCarboxylate Ester (PCE) available on the market was used for optimizing compaction of mix concrete

In the following examples cement paste, mortar according to NF EN 196-1:2016 and mix concrete have been prepared based on components disclosed above.

### Products:

Cement Paste:
   Cement=CEM I or CEM III/B
   Water to cement mass ratio, W/C, of 0.4
EN mortar according to NF EN 196-1:2016
   Cement=CEM I or CEM III/B
   sand to cement mass ratio, S/C, of 3.0
   Water to cement mass ratio, W/C, of 0.50
Concrete mix composition with solid composition according to Table 1 and a water to cement ratio of 0.30.

TABLE 1
Example of mix concrete composition

| | | |
|---|---|---|
| Component | Comment | wt.-% |

| | | |
|---|---|---|
| Cement | CEM I or CEM III/B | 16 |

| | | | |
|---|---|---|---|
| Sand 1 | 0/1 | [mm] | 50 |
| Sand 2 | 1.6 / 3 | [mm] | 10 |
| Sand 3 | 3 / 6 | [mm] | 24 |

### Methods

### Process of Fabrication of Samples

### Cement Paste:

Use of a temperature controlled (20° C.) waring blender.
about 10 to 15 g of paste is spread in aluminium cup of 4 cm in diameter as a layer of about 1 mm

### EN Mortar:

we simply use standard equipment
   Perrier manual mixer
   mold 4×4×16 samples [cm³]
samples are slightly pre-dried before unmolding them:
   20% of initial water is removed from only one face
   then the pre drying is continued on all faces but one 4*16 bottom face, without removing the samples from the bottom plate of the mold. The pre-drying here is a pre-drying for unmolding and then the sample will be further submitted to the pre-drying of the carbonation process

### Concrete Mix:

Mixing of components in a Perrier mixer, with presaturation of sand with water
Forming of cylindrical samples (diameter 10 cm and height 10 cm, i.e. an aspect ratio of 1) or pavers (thickness 8 cm, width 10 cm and length 20 cm) in a gyratory compactor or in a press machine to reach maximum density of the mix, i.e from 50 to 500 cycles depending on the mix
No predrying is required to move these samples

### Process of Carbonation of Samples

The carbonation is a two steps process for all samples, whatever their geometry and composition. The first step is a pre-drying step without CO₂ gas flow addition and the second step is a carbonation step at least at 80% relative humidity.

### Step 1—Pre-Drying

The samples are dried at a temperature ranging from 20 to 80° C. and at a controlled relative humidity (RH), ranging from 10 to 95%.

The drying is stopped once a targeted water content is reached: the drying duration may vary from 15 minutes to a few days depending on conditions and on sample size.

This water content is expressed in terms of remaining mass of liquid water after drying, normalized by the mass of cement in the mix design. The drying rate is varied by changing the temperature and relative humidity in a market available climatic chamber. The conditions are chosen to ensure homogeneity of drying, i.e. by controlling that the mass loss is linear with time.

### Step 2—Carbonation Process

After the pre-drying step the samples are introduced in a market available vacuum oven, which allows both temperature control and gas control (composition, pressure) thanks to gas connections (inlet/outlet)

This oven is called the chamber of the incubator.

Here the gas used is a CO₂ gas flow. The laboratory is equipped with pure CO₂ gas. The CO₂ gas flow may be pre-saturated with water vapor before injection in the chamber of the incubator. A vacuum pump is used to flush the initial air in the chamber of the incubator with the CO₂ gas flow.

The relative humidity is also controlled with a tank of deionized water laid on the bottom of the oven.

The relative humidity is at least above 80%, the temperature ranges from 20 to 80° C. depending on the test.

Further information on the curing process:

### Gas:

Pressure: atmospheric pressure, with slight overpressure to sustain flow (flow with one input, one output)
CO₂: 5 to 100% by volume of the dry gas composition
Temperature: 20-120° C., preferably 60-120° C.

### Flow:

Regulation of inlet flow rate of 0.5 L_gas/L_sample/h to 5 L_gas/L_sample/h (or 10 to 100 hPa difference+CO₂ concentration) according to material

### Chamber:

Ventilation 100 m³/h
Fan location all along the height of the chamber to favor cells
Tight chamber with control leakages (qualification)

### Pre Carbonation Unit:

Presaturation of gas with water at a temperature higher than chamber temperature

### Sensing:

Inlet and Outlet flow
CO₂ concentration of dry gas at inlet and outlet is measured
CO₂ sensors to monitor CO₂ within chamber (N sensor per unit volume)
Temperature

### Regulation:

CO₂ depletion in dynamic conditions (from inlet/outlet data)
CO₂ depletion rate in short term static conditions
Automatic determination of average maturity of cement in elements
   Integral of point measurement of mass flow rate (dynamic and static)

### Method of Measurement of Hydration and Carbonation Amount by Loss-On-Ignition

A/ Total mass gain with respect to cement in the mix.

The total mass gain (Δm, see eq. (3)) is related to both bound water (Δm_H₂O) and bound CO₂ (Δm_CO₂) with respect to the cement [g/g of cement].

After carbonation, the samples are dried at 105° C. to get the final dry mass noted m_f,dry, expressed in grams [g]

The mass of the samples after mixing and before carbonation is known, it is noted m_0,wet and expressed in grams [g]

The mass of the solid, i.e. the dry mass, is calculated from initial mix composition, it is noted m_0,dry and expressed in grams [g]

The weight fraction of cement in the solid mix is known (see Table 1), it is noted m_cem and is a mass ratio in [g/g]

$$Δ m = ( {m}_{fdry} - {m}_{0 , dry} ) / {m}_{0 , dry} \times 1 / {m}_{cem} \qquad ( 3 )$$

B/ CO₂ mass gain with respect to cement in the mix:

The bound water content and bound CO₂ content with respect to the mass of samples is also calculated from the measured mass of samples, respectively at 550° C. and 900° C. The mass difference of samples between 105° C. and 550° C. is related to bound water content (see eq. (4)) whereas the mass loss of samples between 550° C. and 900° C. is related to CO₂ content (see eq. (5)).

$$Δ {m}_{H 2 O} = ( {m}_{f , 105} - {m}_{f , 550} ) / {m}_{f , 900} \times {m}_{f , 900} / {m}_{0 , dry} \times 1 / {m}_{cem} \qquad ( 4 )$$

$$Δ {m}_{CO 2} = ( {m}_{f , 550} - {m}_{f , 900} ) / {m}_{f , 950} \times {m}_{f , 900} / {m}_{0 , dry} \times 1 / {m}_{cem} \qquad ( 5 )$$

Note the sampling of materials that enables averaging the water and CO₂ uptake in case of gradient of between the surface of samples and the core of a samples.
for cement paste the entire samples ([10-15] g) is measured,
for mortar: half of samples [4*4*8] cm³ is measured after the compression tests,
for compacted cylinder or pavers: a quarter of the samples is recovered after the split test (half the height and half the circumference for the cylinder).

### Strength Measurement

The strength is not measured on paste. Those samples are only used to assess bound water and bound CO₂ in a thin sample with no mass transfer limitation through the sample.

EN mortar strength testing according to NF EN 196-1:2016:
a standard PRESSE 3R 300KN is used for flexural and compression test of 4*4*16
3 flexural tests and 6 compressive strength are performed on 3 4*4*16 samples
CS=compressive strength
FS=flexural strength

Mix Concrete split test according to NF-EN-12390-6, 2012
Split tests are run on three replicates

In all examples, % are expressed in weight compared to the total weight of the cement, except specific mention to the contrary.

When a commercial product is available in solution/dispersion form, the content in all examples is expressed by reference to its dry active content.

The abbreviation “cem” means cement. “g_cem” means gram of cement.

### Result

### Example 1: Retarders can Delay Hydration at a Temperature>35° C.

The capacity to delay hydration at the carbonation temperature is checked by running experiments on CEM I mortars.

Two methods are used for assessing the performance of retarder to delay hydration at temperature above ambient temperature (above 35° C.):
bound water content in closed conditions (destructive test)
temperature rise in quasi adiabatic conditions and closed conditions (non-destructive test)

For both methods, the mortars are pre-dried in order to remove half the water before letting the mortar hydrate in a closed system at 70° C.

Table below gives values of bound water in closed conditions when the retarder is a gluconate in a CEM I mortar.

TABLE 2
Bound water in mortar with different gluconate dosage
after 1.5 and 24 h hydration at 70° C. in closed system

| Gluconate dosage | Bound water @ 1.5 h | Bound water @ 24 h |
|---|---|---|
| [g_dry/g_cem] | [g_H₂O/g_cement] | [g_H₂O/g_cement] |
| 0.0 | 0.044 | 0.135 |
| 0.004 | 0.016 | 0.098 |
| 0.006 | 0.016 | 0.045 |
| 0.01 | 0.015 | 0.014 |

Bound water decreases when gluconate dosage increases confirming that the retarder can still delay hydration at a temperature well above ambient temperature, at 70° C.

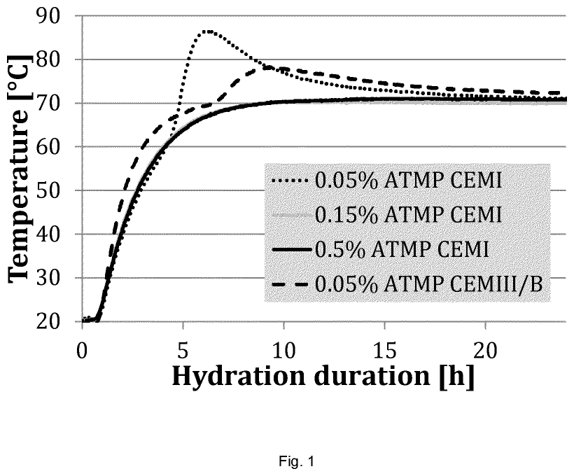

FIG. 1 gives temperature rise in quasi adiabatic conditions and closed conditions for mortar comprising amino Phosphonic acid (ATMP):
dotted line: CEM I mortar comprising 0.05% by weight, compared to the weight of the cement, of ATMP;
grey line: CEM I mortar comprising 0.15% by weight, compared to the weight of the cement, of ATMP;
black line: CEM I mortar comprising 0.5% by weight, compared to the weight of the cement, of ATMP
hashed line: CEM III/B mortar comprising 0.05% by weight, compared to the weight of the cement, of ATMP.

At a concentration of 0.05 wt % by weight of ATMP, a hydration peak appears in the temperature time evolution of the mortar, indicating that hydration at least partially takes place.

On the contrary, ATMP at a concentration of at least 0.15 wt % is efficient for delaying hydration.

### Example 2: Carbonation Enhancement—Cement Paste

In this example, CEM I cement pastes are prepared and carbonated as described above and below.

All cement pastes have the same initial water content.
Step 1—predrying: 0.5 to 2 hours at 70° C. at a relative humidity of 5% for all samples, in order to reach a water content after pre-drying of 0.2 g_H₂O/g_cem
Step 2—carbonation: duration: 24 hours, temperature 70° C., 100% v/v CO₂ in the dry gas, above 80% RH over pressure of 30 hPa, CO₂ concentration constant
0. Reference—The cement paste does not comprise retarder or accelerator
1. Invention—The cement paste comprises retarder (0.6% gluconate) and accelerator (1% TEA)
2. Invention—The cement paste comprises retarder (2% saccharose) and accelerator (1% TEA)
3. Invention—The cement paste comprises retarder (1% EDTA) and accelerator (1% TEA)
4. Invention—The cement paste comprises retarder (0.5% ATMP) and accelerator (1% TEA)

Results are given in the table below:

TABLE 3
CO₂ uptake for various cement pastes,
with different retarder dosage and type

| | | | H₂O uptake | CO₂ uptake |
|---|---|---|---|---|
| | Retarder | Accelerator | [g_H₂O/ | [g_CO₂/ |
| N | [Type (dosage)] | [Type (dosage)] | g_cement] | g_cement] |
| 0 | no | no | 0.08 | 0.20 |
| 1 | Gluconate (0.6%) | TEA (1%) | 0.07 | 0.25 |
| 2 | Saccharose (2%) | TEA (1%) | 0.08 | 0.33 |
| 3 | EDTA (1.0%) | TEA (1%) | 0.09 | 0.34 |
| 4 | ATMP (0.5%) | TEA (1%) | 0.09 | 0.32 |

We show that admixtures (retarder and accelerator) can enhance the CO₂ uptake of CEM I cement in thin paste after 24h in the chamber of the incubator.

### Example 3: Carbonation Enhancement—Mortar

In this example, CEM I EN mortar, having the W/C content disclosed above, are prepared and carbonated as described above and below.

All mortars have the same initial water content.
Step 1—predrying: 1-2 hours at 80° C. at a relative humidity of <5% for all samples, water content after pre-drying: 7-9% g_H2O/g_solid
Step 2—carbonation: duration: 24 hours, temperature: 70° C., 100% v/v CO₂ in the dry gas, above 80% RH over pressure of 30 hPa, CO₂ concentration constant

Results are given in the table below:

TABLE 4
EN mortar properties

| Retarder | Accelerator | H₂O uptake | CO₂ uptake | |
|---|---|---|---|---|
| [Type | [Type | [g_H₂O/ | [g_CO₂/ | CS |
| (dosage)] | (dosage)] | g_cement] | g_cement] | MPa |
| None | None | 0.18 | 0.13 | 58 |
| Gluconate (1%) | no | 0.07 | 0.18 | 36.7 |
| Gluconate (0.6%) | no | 0.08 | 0.29 | 48.5 |
| Gluconate (1%) | TEA (1%) | 0.11 | 0.31 | 61.3 |
| Saccharose (2%) | no | 0.10 | 0.28 | 64.4 |

The strength development after 24 h of carbonation at 70° C. for CEM I EN mortar is verified with different retarder and accelerator. The addition of gluconate enables reaching good CO₂ uptake. The addition of TEA can further successfully enhance carbonation. Performance can be obtained with Saccharose, even in the absence of TEA. The sample without retarder nor accelerator does develop strength but the strength is governed by large amount of bound water [0.18] at the cost of the lowest CO₂ uptake [0.13].

### Example 4: Carbonation Enhancement—Dry Mix Concrete—10*10 cm*cm Cylinder

In this example, dry mix concretes, having the composition and W/C content disclosed above, are prepared and carbonated as described above and below. The cement is CEM I cement.

The samples are cylinders with dimension Φ*H=10*10 cm*cm.

All dry mix concretes have the same initial water content.
Step 1—predrying: 1-2 hours at 80° C. at a relative humidity of <5% for all samples, water content after pre-drying: 2-3 g_H₂O/g_solid
Step 2—carbonation: duration: 24 h, temperature: 70° C., 100% v/v CO₂ in the dry gas, above 80% RH over pressure of 30 hPa, CO₂ concentration constant

Results are given in the table below:

TABLE 5
mix concrete properties

| | H₂O uptake | CO₂ uptake | |
|---|---|---|---|
| | [g_H₂O/ | [g_CO₂/ | Split |
| Admixture | g_cement] | g_cement] | MPa |
| none | 0.072 | 0.114 | 2.7 |
| Gluconate (0.6%)/TEA (1%) | 0.08 | 0.186 | 3.8 |

One can see that both bound CO₂ and bound water can be maximized with the use of both the gluconate retarder and the TEA accelerator.

For this geometry the performance threshold of split strength is 3 MPa. This threshold is exceeded for mix design with admixture, while maximizing the CO₂ uptake.

### Example 5: Carbonation Enhancement—Dry Mix Concrete—Pavers

In this example, dry mix concrete, having the composition and W/C content disclosed above, are prepared and carbonated as described above and below. The cement is CEM I or CEM III/B cement. The samples are pavers of 8 cm in thickness disclosed above. All pavers contain a superplasticizer, a retarder (gluconate) and a carbonation booster (TEA).

All dry mix concretes have the same initial water content.
Step 1—predrying: 1-2 hours at 80° C. at a relative humidity of <5% for all samples, water content after pre-drying: 2-3 g_H₂O/g_solid
Step 2—carbonation: duration: 48 h, temperature: 70° C., 100% v/v CO₂ in the dry gas, above 80% RH over pressure of 30 hPa, CO₂ concentration constant

Results are given in the table below:

TABLE 6
Pavers properties

| | | H₂O uptake | CO₂ uptake | |
|---|---|---|---|---|
| | Cement | [g_H₂O/ | [g_CO₂/ | Split |
| Admixture | type | g_cement] | g_cement] | [MPa] |
| Gluconate (0.4%)/ | CEM I | 0.023 | 0.27 | 5.1 |
| TEA (1%) | | | | |
| Gluconate (0.2%)/ | CEM III/B | 0.014 | 0.19 | 3.8 |
| TEA(1%) | | | | |

One can see that a good performance can be obtained after 48 h.

### Example 6: Effect of Carbonation at 70° C. on Strength Development

In this example, CEM I EN mortar, having the W/C content disclosed above, are prepared and carbonated as described above. All mortars comprise admixtures. The admixture is gluconate at 0.4% dosage. The difference in carbonation temperature is highlighted.

All mortars have the same initial water content.
Step 1—predrying: 1-2 hours at 80° C. at a relative humidity of <5% for all samples, water content after pre-drying: 5-6 g_H₂O/g_solid.
Step 2—carbonation: duration: 24 hours, temperature: 20° C. or 70° C., 100% v/v CO₂ in the dry gas, above 80% RH over pressure of 30 hPa, CO₂ concentration constant

Results are given in the table below:

TABLE 7
mortar property obtained after carbonation at 20° C. and 70° C.

| | Temper- | H₂O uptake | CO₂ uptake | | |
|---|---|---|---|---|---|
| | ature | [g_H₂O/ | [g_CO₂/ | CS | FS |
| Admixtures | [° C.] | g_cement] | g_cement] | MPa | MPa |
| Gluconate (0.4%) | 70 | 0.08 | 0.24 | 35.5 | 4.6 |
| Gluconate (0.4%) | 20 | 0.09 | 0.22 | 25.1 | 3.9 |

In spite of similar bound water (˜0.10 [g/g]) and CO₂ content (˜0.25 [g/g]) after carbonation, the strength development is further improved after carbonation at 70° C.

1. Method of preparation of a construction element by carbonation, comprising the consecutive steps of:
a) preparing a composition containing a cement, water and chemical additives; then
b) pre-drying the composition; then
c) placing the pre-dried composition in a chamber of an incubator
the chamber of the incubator contains at least one inlet and one outlet,
the pre-dried composition is carbonated, in a carbonation step, by feeding into the chamber of the incubator, through the inlet, a flow of CO₂ containing gas,
variations of the CO₂ concentration in the chamber of the incubator are kept below 10% of a reference value during the whole carbonation step,
during the carbonation step, the pressure within the chamber of the incubator is atmospheric pressure or with slight overpressure, the relative humidity within the chamber of the incubator is above 80° % and the temperature within the chamber of the incubator is ranging from 20° C. to 80° C.,
wherein the chemical additives in the composition comprise more than 0.05% in weight, compared to the total weight of the cement, of a cement hydration retarder,
wherein the additives further contain a carbonation accelerator selected from the group consisting of triethylamine (TEA), triisopropanolamine (TIPA), calcium salts, sodium salts and mixtures thereof,
the composition comprises from 0.1% to 3%, of the carbonation accelerator, the percentages are expressed in weight compared to the total weight of the cement.

2. Method according to claim 1, wherein the composition comprises more than 0.05% to 3% of the cement hydration retarder, the percentages are expressed in weight compared to the total weight of the cement.

3. Method according to claim 1, wherein the cement hydration retarder is selected from the group consisting of sodium gluconate, Amino Tris Methylene Phosphonic acid (ATMP), saccharose, or Ethylene Diamine Tetraacetic acid (EDTA) and mixtures thereof.

4. Method according to claim 1, wherein the cement hydration retarder is selected from the group consisting of ATMP, EDTA and mixtures thereof.

5. Method according to claim 1, wherein calcium salts are selected from the group consisting of Ca(NO₃)₂, CaCl₂ or mixtures thereof and sodium salts are selected from NaHCO₃, Na₂CO₃, NaCl and mixtures thereof.

6. Method according to claim 1, wherein the composition comprises from 0.1% to 1%, of TEA, TIPA or sodium salts, the percentages are expressed in weight compared to the total weight of the cement.

7. Method according to claim 1, wherein the cement comprises at least 20% in weight compared to the total weight cement, of Portland clinker.

8. Method according to claim 1, wherein the cement comprises mineral component selected from the group consisting of granulated blast furnace slag, pozzolanic materials, fly ashes, burnt shale, limestone, silica fume and combinations thereof.

9. Method according to claim 1, wherein the cement is selected from a CEM I or a CEM III.

10. Method according to claim 1, wherein the composition of step a) has a weight water/cement ratio below 0.6.

11. Method according to claim 1, wherein the composition of step a) is a cement paste, a mortar, or a concrete.

12. Method according to claim 1, wherein step b) is conducted at a temperature ranging from 20 to 80° C. and at a controlled relative humidity, ranging from 10 to 95%.

13. Method according to claim 1, wherein step b) is conducted until the composition has a water content ranging from 0.1 to 0.3.

14. Method according to claim 1, wherein during the carbonation step, one or many of the following conditions are satisfied:
the temperature within the chamber of the incubator is ranging from 60° C. to 80° C.;
the relative humidity within the chamber of the incubator is above 90%;
the chamber of the incubator is ventilated.

15. (canceled)

16. Method according to claim 1, wherein the composition comprises preferably from 0.1% to 3%, preferably from 0.1% to 1%, of the cement hydration retarder, the percentages are expressed in weight compared to the total weight of the cement.

17. Method according to claim 1, wherein the cement comprises at least 50% in weight compared to the total weight cement, of Portland clinker.

18. Method according to claim 1, wherein the composition of step a) has a weight water/cement ratio below 0.4, preferably below 0.32.

19. Method according to claim 1, wherein step b) is conducted until the composition has a water content ranging from 0.1 to 0.2.

20. A method for improving CO₂ uptake of a cement composition after carbonation, comprising adding a chemical additive comprising cement hydration retarder in the cement composition,
the composition comprising more than 0.05% in weight, compared to the total weight of the cement, of the cement hydration retarder,
wherein the chemical additive further comprises carbonation accelerator.
